(19) United States
(12) Patent Application Publication
(10) Pub. No.: US 2025/0116782 A1
(43) Pub. Date: Apr. 10, 2025

(54) METHOD AND APPARATUS FOR MITIGATION OF GNSS-SIGNAL INTERFERENCE

(71) Applicant: TOPCON POSITIONING SYSTEMS, INC., Livermore, CA (US)

(72) Inventors: Alexey Vyacheslavovich MESHCHERYAKOV, Moscow (RU); Fedor Borisovich SERKIN, Moscow (RU)

(73) Assignee: TOPCON POSITIONING SYSTEMS, INC., Livermore, CA (US)

(21) Appl. No.: 18/865,712

(22) PCT Filed: May 23, 2022
(86) PCT No.: PCT/RU2022/000171

§ 371 Date: Nov. 14, 2024

(51) Int. Cl. G01S 19/21; G01S 19/36

(52) U.S. Cl. CPC G01S 19/21; G01S 19/36

(57) ABSTRACT

A method and apparatus for mitigation of GNSS-signal interference using an adaptive notch filter (ANF) operates based on signals received from one or more satellites of a Global Navigation Satellite System (GNSS) such as GPS, GLONASS, etc. In one embodiment, an apparatus comprises a notch filter having a tunable zero frequency of a transfer function receives an input signal and generates an output signal. A bandpass filter coupled to the output of the notch filter receives the output signal. An adaptive block is coupled to the bandpass filter and adjusts the notch filter parameters in order to achieve the minimization of a specific cost function.

### FIELD OF THE INVENTION

The present disclosure relates generally to methods for filtering, and, more particularly, to a method and apparatus for mitigation of GNSS-signal interference using an adaptive notch filter.

### BACKGROUND

The transmission of signals is typically subject to interference from multiple sources. Sources of interference can be natural or man-made and may also be intentional or unintentional. Interference and noise can prevent operations that require receipt of a useful signal. For example, thermal noise or interference jamming (e.g., signal blocking), can cause signal loss and prevent operations that require receipt of the transmitted signal. Global navigation satellite system (GNSS) signals from the satellites of those systems are typically weak in strength and, therefore, susceptible to interference. What is needed is a method to mitigate signal interference.

### SUMMARY

In one embodiment, an apparatus comprises a notch filter having a tunable frequency of a transfer function zero (also referred to as the “zero frequency”) and configured to receive an input signal and generate an output signal. A bandpass filter is coupled to an output of the notch filter and configured to receive the output signal. An adaptive block is coupled to the bandpass filter and configured to adjust the notch filter parameters in order to minimize a specific cost function. In one embodiment, the notch filter is a digital complex filter of a 1st order, wherein the input of the digital complex filter is coupled to an input of the apparatus and the frequency of the transfer function zero of the digital complex filter is equal to an interference frequency when adaptation is complete. In one embodiment, the bandpass filter is a digital complex filter of a 1st order having a pole frequency that coincides with the zero frequency of the notch filter. The digital complex filter has a bandpass filter transfer function, and the input of the digital complex filter is coupled to an output of the apparatus. In one embodiment, the adaptive block is configured to track an interference frequency and adjust the filter zero in order to achieve minimization of a cost function, the input of the adaptive block is coupled to the output of the bandpass filter. In one embodiment, the apparatus is configured to mitigate multi-spectral interference with the notch filter having a particular transfer function. In one embodiment, a highpass filter is shifted using real coefficients by multiplying the real coefficients by a power function of the complex exponent. A method is also described having the step of receiving an input signal from one or more global navigation satellite system satellites. The input signal is filtered by a notch filter and input to a bandpass filter, the output signal of which is input to the adaptive block, which adjusts the notch filter parameters in accordance with a Least Mean Squares (LMS) algorithm. An apparatus comprising a processor and a memory coupled to the processor is also described. The memory storing computer program instructions that when executed cause the processor to perform operations.

### BRIEF DESCRIPTION OF THE DRAWINGS

FIG. 1 shows an interference mitigation system of a Global Navigation Satellite System (GNSS) receiver having a notch filter and adaptive block according to one embodiment;

FIG. 2 shows an adaptive notch filter of a GNSS receiver according to one embodiment;

FIG. 3 shows a graph of spectral density reduction of noise by a bandpass filter according to one embodiment;

FIG. 4 shows a digital complex 1^{st} order bandpass filter of a GNSS receiver according to one embodiment.

FIG. 5 shows a spectrum of the bandpass filter shown in FIG. 4;

FIG. 6 shows a digital complex 3^{rd} order filter of a GNSS receiver according to an embodiment;

FIG. 7 shows a graph depicting the frequency response of the digital complex 3^{rd} order filter shown in FIG. 6;

FIG. 8 shows a graph of the frequency response of the digital complex notch filter by shifting the highpass filter with real coefficients; and

FIG. 9 shows a high-level block diagram of a computer for performing operations of the components described herein according to an embodiment.

### DETAILED DESCRIPTION

A method and apparatus for mitigation of GNSS-signal interference using an adaptive notch filter (ANF) operates based on signals received from one or more satellites of a Global Navigation Satellite System (GNSS) such as GPS, GLONASS, etc.

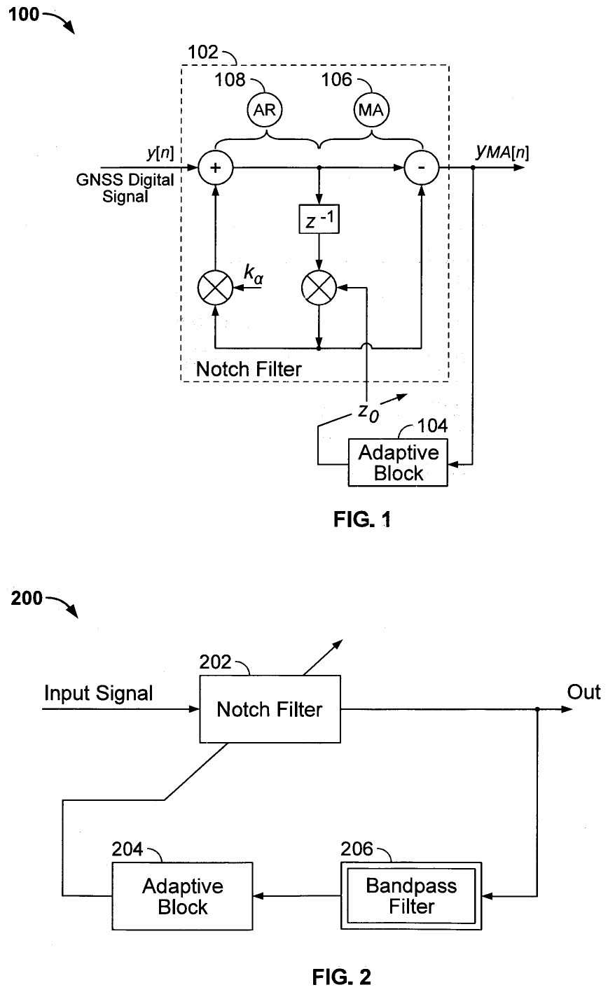

FIG. 1 shows an interference mitigation system 100 of a GNSS receiver. Interference mitigation system 100 comprises notch filter 102 and adaptive block 104. In one embodiment interference mitigation system 100 is used to mitigate intentionally caused interference. For example, mitigation system 100 can be used for anti-jamming of a signal that is being jammed (or blocked using interference). A signal y(t) at the input of GNSS receiver may contain both thermal noise and interference. After filtering (e.g., by an RF-bandpass filter), down-converting, and analog-to-digital conversion (ADC) using sampling frequency fₛ=(Tₛ)⁻¹, the resulting GNSS digital signal y[n] at an input of notch filter 102 of interference mitigation system 100 of the GNSS receiver can be represented as:

$$y [ n ] = x [ n ] + i [ n ] + η [ n ] , \qquad ( 1 )$$

where, x[n]=Σₖxₖ[n] is a combination of GNSS signals from different satellites, i[n]—is an interference signal, and η[n]—is thermal noise with spectral density N₀.

GNSS signal interference mitigation in the time domain can involve the removal of the interference signal i[n]from the signal y[n]:

$$\tilde{y} [ n ] = y [ n ] - i [ n ] . \qquad ( 2 )$$

Narrowband quasi-harmonic interference and a chirp signal can be represented in the following single-component form:

$$i [ n ] = A [ n ] exp \{ j φ [ n ] \} . \qquad ( 3 )$$

In this scenario, the instantaneous value of the interference signal frequency (equation 3) has the form:

$${f}_{i} [ n ] = \frac{1}{2 π T \text{?}} ( φ [ n ] - φ [ n - 1 ] ) . \qquad ( 4 )$$

$$\text{?} \text{indicates text missing or illegible when filed}$$

In the case of a single-component signal equation (3), a prediction regarding the form of the interference signal i[n] from the previous sample i[n−1]can be used as follows:

$$i [ n ] = a [ n ] i [ n - 1 ] . \qquad ( 5 )$$

The expression for the coefficient a[n] can be obtained from equations (3) and (5) taking into account that, for neighboring samples, if the noise amplitude is considered to not change, then the coefficient of linear prediction of the error signal is determined by estimating only the instantaneous value of the interference frequency fᵢ:

$$a [ n ] = \frac{i [ n ]}{i [ n - 1 ]} = \frac{A [ n ]}{A [ n - 1 ]} exp \{ j ( φ [ n ] - φ [ n - 1 ] ) \} = \frac{A [ n ]}{A [ n - 1 ]} exp \{ j 2 π {f}_{i} [ n ] {T}_{S} \} ≅ exp \{ j 2 π {f}_{i} [ n ] {T}_{S} \} . \qquad ( 6 )$$

In one embodiment, an interference mitigation system for a GNSS receiver uses a digital notch filter with complex transfer function of 1^{st} order (also referred to as a digital complex filter of a 1^{st} order) with a transfer function:

$${H}_{n} ( z ) = \frac{1 - {z}_{o} [ n ] {z}^{- 1}}{1 - {k}_{α} {z}_{o} [ n ] {z}^{- z}} = {H}_{AR} ( z ) {H}_{MA} ( z ) , \qquad ( 7 )$$

where z₀[n]—is complex zero of the transfer function (equation (7)), and k_{α}<1—is the real coefficient at the pole of the filter's transfer function.

The transfer function numerator of equation (7) is referred to as the Moving Average (MA) part. MA components 106 shown in FIG. 1 are used in one embodiment to implement the function numerator of equation (7). The MA part, in one embodiment, is used for interference signal mitigation. An output signal after passing the MA part with filter transfer function H_{MA}(z)=1−z₀[n]z⁻¹ can be presented as:

$${y}_{MA} [ n ] = y [ n ] - {z}_{0} [ n ] y [ n - 1 ] = x [ n ] - {z}_{0} [ n ] x [ n - 1 ] + ( i [ n ] - {z}_{0} [ n ] i [ n - 1 ] ) + η [ n ] - {z}_{0} [ n ] η [ n - 1 ] . \qquad ( 8 )$$

From equation (8), it follows that a single-component interference signal is mitigated when the interference signal estimate (equation (6)) coincides with the zero value of the notch filter tuned to the interference with the filter transfer function (equation (7)) which can be shown as:

$${z}_{0} [ n ] = \frac{i [ n ]}{i [ n - 1 ]} = a [ n ] . \qquad ( 9 )$$

The autoregressive (AR) part of the filter transfer function

$${H}_{AR} ( z ) = \frac{1}{1 - {k}_{α} {z}_{o} [ n ] {z}^{- 1}}$$

reduces the MA influence on the distortion of the desired (i.e., useful) signal by narrowing the rejection bandwidth of the filter. AR components 108 shown in FIG. 1 are used in one embodiment to implement the AR part of the filter transfer function. The frequency distortion of the desired signal is smaller, the closer the value of the coefficient k_{α} is to unity.

In accordance with the Least Mean Squares (LMS) algorithm, the search for the optimal value (also referred to as the target value) of the zero frequency of the notch filter is performed iteratively at each sample. The direction of the search and the value of the corrective additive itself is related to the value of the gradient of the cost function, which is equal to the power of the output signal:

$$J [ n ] = E \{ {\vert {x}_{f} [ n ] \vert}^{2} \} , \qquad ( 10 )$$

where x_{f}[n]—is the output signal of the MA block in the notch filter. With successful adaptation, i.e. reaching the minimum of the cost function, the zero frequency of the notch filter coincides with the interference frequency with a given accuracy.

The limitation in increasing the interference mitigation depth is the reduction in the ratio of the interference signal power at the output of the notch filter J to the noise power

$$N = {N}_{0} B : \frac{j}{N} ∼ \frac{E \{ {\vert {x}_{f} [ n ] \vert}^{2} \}}{{N}_{o} \cdot B} ,$$

where N₀—is the thermal noise spectral density, and B—is the bandwidth of useful GNSS signal.

For a two-sided spectrum of a digital signal with the Nyquist frequency fₛ/2, bandwidth frequency is B=2·(fₛ/2)=fₛ. In the case of a narrowband interference signal, it is not generally possible to achieve a reduction in the spectral density of the interference signal to the level of the spectral density of thermal noise due to the much smaller bandwidth of the interference signal ΔΩᵢ compared to the bandwidth of the noise:

$$\frac{Δ {ω}_{i}}{2 π} << {f}_{S} .$$

FIG. 2 shows an adaptive notch filter 200 of a GNSS receiver according to an embodiment. Bandpass filter 206 is arranged at the input of adaptive block 204. The use of a bandpass filter at the input of the adaptive block allows increase of the depth of mitigation of harmonic interference (e.g., continuous wave (CW) interference) and chirp interference by an additional 20 dB compared to other ANF-based interference mitigation systems that can be used for anti-jamming. Bandpass filter 206 has a central frequency coinciding with the zero frequency of notch filter 202. In one embodiment, notch filter 202 has a tunable frequency of a transfer function zero. In one embodiment, bandpass filter 206 is a digital complex filter. After a signal is processed by bandpass filter 206, the contribution of the power of the thermal noise signal present in the output signal of notch filter 202 will decrease in adaptative block 204 when adaptive block 204 is calculating the cost function gradient.

It should be noted that bandpass filter 206 located at the input of adaptive block 204 does not change the signal in the direct transmission channel, since a bandpass filter is used in a computational circuit of the adaptive notch filter 200 of the GNSS receiver.

The width of the rejection/stop band of notch filter 202 with the transfer function of the form shown in equation (7) is B_{-3 dB}=(1−k_{α})fₛπ/10. In one embodiment, it is assumed that the stop band of notch filter 202 coincides with the frequency band of the interference signal (B_{-3 dB}=ΔΩᵢ). When the bandwidth of notch filter 202 is related to the bandwidth of the interference signal, then reduction in noise level at the input of adaptive block 204 and a gain in the ratio J/N is

$${f}_{s} / ( \frac{Δ {ω}_{i}}{2 π} ) ∼ \frac{1}{1 - {k}_{α}} .$$

FIG. 3 shows graph 300 of noise spectral density reduction with bandpass filter 202. As shown in FIG. 3, input noise signal 302 has a uniform power spectral density (PSD) distribution over the frequency range from −80 MHZ to 80 MHz. Bandpass output signal 304 has a resonant response with a center frequency of approximately 23 MHz.

A bandpass filter at the input of the adaptive block should be tunable because, during the adaptation of the notch filter, its pole-frequency changes, also tuning to the frequency of the interference signal. But the adjustment of the digital filter requires recalculation of the transfer function coefficients in real-time. For example, in one embodiment, a biquad filter is used as a bandpass filter with a resonant frequency Ωᵢ=2πfᵢ and Q-factor Q. After bilinear frequency transformation

$$s = \frac{2}{{T}_{s}} \cdot \frac{1 - {z}^{- 1}}{1 + {z}^{- 1}}$$

of the biquad, which is an analog embodiment, the transfer function of the digital biquad in the z-domain has the following form:

$$H ( z ) = G \cdot \frac{1 - {z}^{- 2}}{1 + {a}_{1} {z}^{- 1} + {a}_{2} {z}^{- 2}} \qquad ( 11 )$$

$$where$$

$$G = \frac{{( β Q )}^{- 1}}{( 1 + {β}^{- 2} + {( β Q )}^{- 1} )} , {a}_{1} = \frac{- 2 ( 1 - {β}^{- 2} )}{1 + {β}^{- 2} + {( β Q )}^{- 1}} , {a}_{2} = \frac{1 + {β}^{- 2} - {( β Q )}^{- t}}{1 + {β}^{- 2} + {( β Q )}^{- 1}} β = \frac{{F}_{S}}{π {f}_{i}} . ,$$

To adjust the resonant frequency of a digital filter with transfer function (equation (11)), the coefficients a₁ and a₂ are changed. In one embodiment, the zero frequency of a transfer function of the digital complex filter is equal to the interference frequency when adaptation is complete.

In addition, after frequency conversion, distortions in the frequency characteristics occur, the level of which increases as the resonant frequency approaches the Nyquist frequency. There is a shift in the value of the resonant frequency from the calculated value. To accurately implement a digital filter at the frequency Ω, predistortion (see equation (8)) is introduced according to

$${ω}^{′} = \frac{2}{{T}_{s}} tg ( \frac{ω {T}_{s}}{2} ) .$$

In this case coefficient β in expression (11) should be in the form:

$$\frac{1}{\hat{β}} = tg ( \frac{1}{β} ) .$$

As a result, when tuning the zero frequency of the notch filter in the adaptation process, it is required to calculate the coefficients of the transfer function of the digital biquad filter with the sampling frequency according to the following equations:

$${a}_{1} = \frac{- 2 ( 1 - {\hat{β}}^{- 2} )}{1 + {\hat{β}}^{- 2} + {( \hat{β} Q )}^{- 1}} , {a}_{2} = \frac{1 + {\hat{β}}^{- 2} - {( \hat{β} Q )}^{- 1}}{{1 + {\hat{β}}^{- 2} + \hat{( β} Q )}^{- 1}} . \qquad ( 12 )$$

Equations (12) require relatively large computational resources when implementing interference mitigation with a Field Programmable Gate Array (FPGA).

The transfer function with real coefficients (see equation (11)), in the general case, has complex conjugate zeros and poles. For a two-sided spectrum, the frequency response of a filter with real coefficients has a symmetrical response, both in the positive frequency region and in the conjugate negative part. But the interference signal, as a rule, is located in one of the two conjugate parts of the spectrum. Then the bandpass filter with a real transfer function has an excess bandwidth in the conjugate part of the spectrum, where there is no interference signal, which at least impair the value of the ratio J/N by 3 dB.

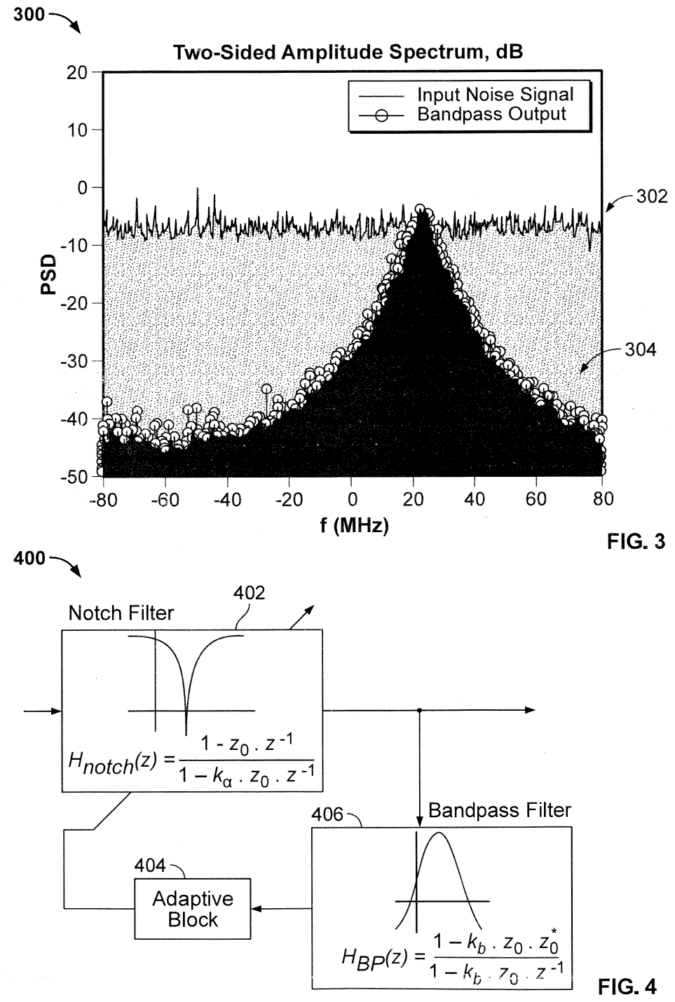

FIG. 4 shows filter section 400 of a GNSS receiver according to an embodiment having a digital complex 1^{st} order bandpass filter. Filter section 400 has bandpass filter 406 at the input of adaptive block 404. Bandpass filter 406 has a complex transfer function that provides selectivity in only one of the two conjugate parts of the two-sided spectrum.

In one embodiment, bandpass filter 406 operates as a transfer function, specifically:

$${H}_{bp} ( z ) = \frac{1 - {k}_{b} {z}_{0} {z}_{0}^{*}}{1 - {k}_{\text{?}} {z}_{\text{?}} {z}^{- 1}} . \qquad ( 13 )$$

$$\text{?} \text{indicates text missing or illegible when filed}$$

In one embodiment, bandpass filter 406 has the following characteristics:

The transfer function shown in equation (13) corresponds to a digital complex 1^{st} order bandpass filter with a complex pole z=k_{b}z₀=k_{b}e^{jΩ}^{₀}^{T}^{_{S}}, where

$$\frac{{ω}_{0}}{2 π} -$$

is zero frequency of the transfer function of notch filter 402 (see equation (7)), i.e., the value of the resonant frequency of the proposed bandpass filter coincides with the zero frequency of the transfer function of notch filter 402.

The real coefficient k_{b}<1 determines the bandwidth of the bandpass filter, the value of which can also be estimated by the formula B_{-3 dB}=(1−k_{b})f_{S}π/10. The closer the value of the k_{b} coefficient is to one, the smaller the bandwidth of the given band pass filter.

The transfer coefficient of the proposed filter at the resonant frequency z=z₀=e^{jΩ}^{₀}^{T}^{_{S}} is equal to:

$${H}_{bp} ( {z}_{0} ) = \frac{1 - {k}_{b} {z}_{0} {z}_{0}^{*}}{1 - {k}_{b} {z}_{0} {z}_{0}^{- 1}} = 1 , since {z}_{0}^{- 1} = {z}_{0}^{*} .$$

Finally, the bandpass complex filter operating in accordance with the transfer function shown in equation (13) guarantees the selectivity only in one (of two) conjugate parts of two-sided frequency spectrum.

In one embodiment, the bandpass filter comprises a digital complex 1st order filter having a pole frequency that coincides with the zero frequency of the notch filter, the digital complex filter having a transfer function of

$${H}_{bp} ( z ) = \frac{1 - {k}_{b} {z}_{0} {z}_{0}^{*}}{1 - {k}_{\text{?}} {z}_{\text{?}} {z}^{- 1}} .$$

$$\text{?} \text{indicates text missing or illegible when filed}$$

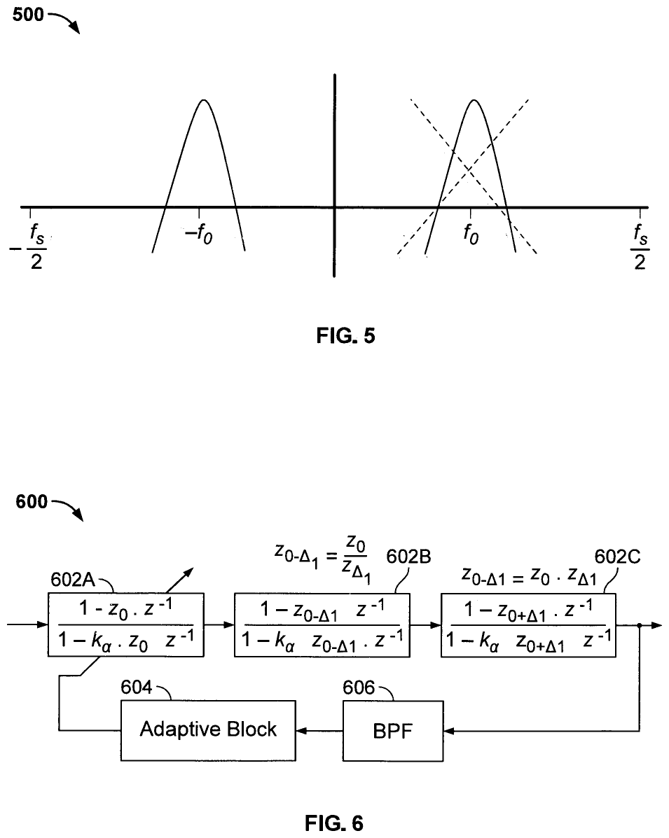

FIG. 5 shows spectrum 500 of bandpass filter 406 operating in accordance with the transfer function shown in equation (13) and having the characteristics described above.

Methods for mitigating interference are generally limited to mitigating only one type of interference. For example, the PB (pulse blanker) method works satisfactorily with wideband pulsed interference signals, but is not designed to deal with continuous interference. Multi-spectral methods using discrete Fourier transformation (DFT), discrete Wavelet Transform (DWT) or Karhunen-Loève transform (KLT) provide great flexibility for interference mitigation, but require very large computational resources.

The adaptive notch filtering (ANF) method described herein provides advantageous results in the case of quasi-harmonic interference and chirp signals, but may be considered less effective for mitigation of multi-spectral or impulse interference signals. However, the effectiveness of the adaptive notch filtering method can be increased as follows.

In one embodiment, a notch-type digital complex 1^{st} order bandpass filter operates according to the transfer function of equation (7). The digital complex 1^{st} order bandpass filter described herein does not require additional computing resources to recalculate the transfer function and provides tracking and mitigating of chirp-interference with a frequency rate up to 10 MHz/μs. In one embodiment, the adaptive block is configured to track an interference frequency and adjust the filter zero in order to achieve minimization of a cost function. In operation of the digital complex 1^{st} order filter, the real coefficient k_{α}simultaneously affects the signal mitigation depth and the rejection bandwidth. To mitigate broadband (or, for example, multi-spectral type OFDM signal) interference, the rejection band of the notch filter is increased, i.e. k_{α} is diminished. But in this case, the degree of signal mitigation in the stopband is reduced. To resolve this contradiction, the filter order is increased and the stopband of the notch filter is expanded. One of two possible solutions may be implemented to resolve the contradiction.

In the first approach, a digital complex 3rd order filter is used consisting of three cascaded notch filters with the resulting transfer function in the form:

$${H}_{Notch} ( z ) = {H}_{1} ( z ) \cdot {H}_{2} ( z ) \cdot {H}_{3} ( z ) = \frac{1 - {z}_{0} {z}^{- 1}}{1 - {k}_{α} {z}_{0} {z}^{- 1}} \cdot \frac{1 - {z}_{0 + {Δ}_{1}} {z}^{- 1}}{1 - {k}_{α} {z}_{0 + {Δ}_{1}} {z}^{- 1}} \cdot \frac{1 - {z}_{0 - {Δ}_{1}} {z}^{- 1}}{1 - {k}_{α} {z}_{0 - {Δ}_{1}} {z}^{- 1}} ,$$

$$where {z}_{0} = {e}^{j {ω}_{0} {T}_{S}} , {z}_{0 + {Δ}_{1}} = {z}_{0} {e}^{j {ω}_{1} {T}_{S}} , {z}_{0 - {Δ}_{1}} = {z}_{0} {e}^{j {ω}_{1} {T}_{S}} .$$

FIG. 6 shows filter section 600 of a GNSS receiver including a digital complex 3rd order filter as described above having three cascaded notch filters 602A, 602B, and 603C. GNSS receiver 600 also has adaptive block 604 with bandpass filter 606 at its input.

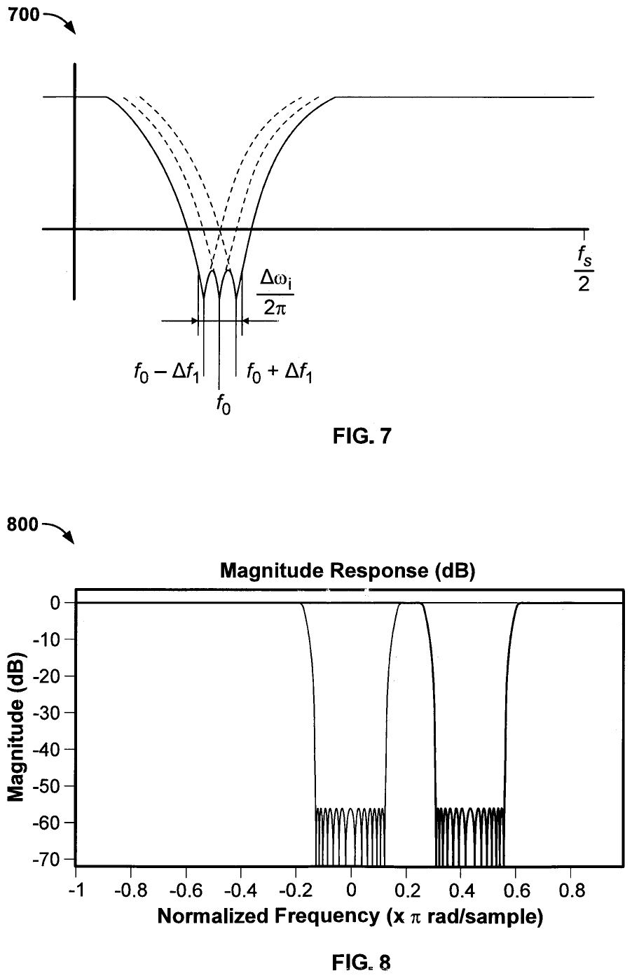

FIG. 7 shows graph 700 depicting the frequency response of the digital complex 3rd order filter shown in FIG. 6.

It should be noted that when changing (i.e., tuning) during adaptation, the zero frequency of the notch filter f₀, the value Δf₁, which determines the rejection band, does not need to be changed. The value of the complex poles of these additional two 1^{st} order filters z_{0±Δ}, does not require complicated calculations, it is determined by the sum of the arguments of two complex numbers.

In general, for multi-spectral interference with a larger bandwidth, it is required to increase the order of the notch filter. In addition, the location of zeros in the approximation function must be symmetrical about the central frequency. The transfer function of such a filter can be represented as:

$${H}_{Notch} ( z ) = {H}_{1} ( z ) \cdot {H}_{2} ( z ) \cdot {H}_{3} ( z ) … {H}_{2 k} ( z ) \cdot {H}_{2 k + 1} ( z ) = \frac{1 - {z}_{0} {z}^{- 1}}{1 - {k}_{α} {z}_{0} {z}^{- 1}} \cdot \frac{1 - {z}_{0 + {Δ}_{1}} {z}^{- 1}}{1 - {k}_{α} {z}_{0 + {Δ}_{1}} {z}^{- 1}} \cdot \frac{1 - {z}_{0 - {Δ}_{1}} {z}^{- 1}}{1 - {k}_{α} {z}_{0 - {Δ}_{1}} {z}^{- 1}} … \frac{1 - {z}_{0 + {Δ}_{k}} {z}^{- 1}}{1 - {k}_{α} {z}_{0 + {Δ}_{k}} {z}^{- 1}} \cdot \frac{1 - {z}_{0 - {Δ}_{k}} {z}^{- 1}}{1 - {k}_{α} {z}_{0 - {Δ}_{k}} {z}^{- 1}}$$

The number of zeroes and their location (Δf₁<Δf₂< . . . <Δfₖ) is determined by the required depth of interference mitigation in the stopband of the 2(k+1)-th order notch filter. The frequency value f₀ must correspond to the center frequency of the interference spectrum, and the value 2·Δfₖ—to the signal width of this interference.

The second approach implements a notch-type high order complex filter for the interference mitigation by shifting the highpass filter with real coefficients by multiplying the real coefficients by a power function of the complex exponent. Either a Finite Impulse Response (FIR) filter with real coefficients of pulse response h(m): yₕₚ(n)=Σₘ₌₀^{M}^{₁}⁻¹h(m)x(n−m), or an Infinite impulse Response (IIR) filter with the transfer function

$${H}_{hp} ( z ) = \frac{{\sum }_{m = 0}^{{M}_{2} - 1} {a}_{m} {z}^{- m}}{{\sum }_{m = 0}^{{M}_{2} - 1} {b}_{m} {z}^{- m}} .$$

can be used as a highpass filter. The highpass filter with real coefficients provides signal attenuation for the two-sided spectrum within band [−Ω_{c}, +Ω_{c}].

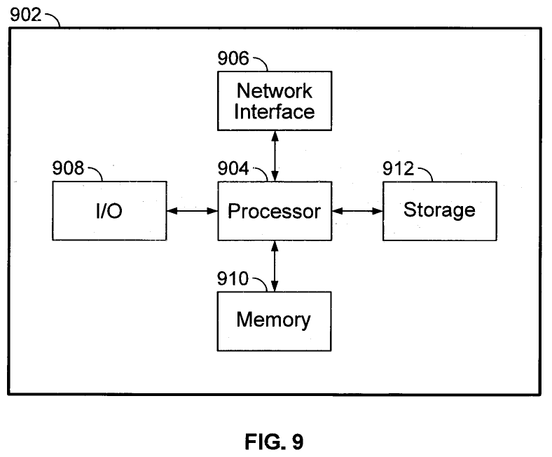

FIG. 8 shows graph 800 of the frequency response of the digital complex notch filter by shifting the highpass filter with real coefficients.

The coefficients of the complex filter are further formed by multiplying the coefficients of the original highpass filter by a power function of the complex exponent: h(m)·e^{-jΩ}^{₀}^{mT}^{_{S}}—in the case of FIR-filter, aₘ·e^{-jΩ}^{₀}^{mT}^{_{S}} and bₘ·e^{-jΩ}^{₀}^{mT}^{_{S}}—in the case of IIR-filter (for all m=0 . . . (M₁₍₂₎−1)).

As a result, the transfer function of the complex IIR filter is obtained

$${H}_{notch} ( z ) = \frac{{\sum }_{m = 0}^{{M}_{2} - 1} {a}_{m} {e}^{- j {ω}_{0} {mT}_{{S}_{z}} - m}}{{\sum }_{m = 0}^{{M}_{2} - 1} {b}_{m} {e}^{- j {ω}_{0} {mT}_{{S}_{z}} - m}} ,$$

or the pulse response characteristic of the complex FIR-filter y_{notch}(n)=Σₘ₌₀^{M}^{₁}−1h(m)·e^{-jΩ}^{₀}^{mT}^{_{S}}·x(n−m).

e^{-jΩ}^{₀}^{mT}^{_{S}} is used as a complex exponent when the notch filter is shifted in the adaptation process, where w₀—is the central frequency of the complex filter. The notch filter synthesized by shifting the frequency characteristic to the central frequency Ω₀ guarantees attenuation within band [Ω_{c}−Ω_{c},Ω₀+Ω_{c}] in accordance with the approximation function of the original highpass filter. The choice of the highpass filter determines the required selectivity of the frequency response, a smaller value of the width of the transition region of the frequency response and, thus, less distortion of the useful signal.

In one embodiment, the method can be used to detect and mitigate multi-spectral interference (type of orthogonal frequency division multiplexing (OFDM) signal) when using high-order notch filter in ANF structure.

The approach and techniques described herein provides detection and

mitigation of not only single-component interference (CW and chirp), but also multi-spectral interference, which gives a qualitative advantage over other works devoted to ANF-based interference mitigation systems.

The techniques described herein can be used for detecting and mitigating not only single-component interference (like CW and chirp), but also for combating multi-spectral wideband interference.

In one embodiment, a computer is used to perform the operations of the components and equations described herein and shown, for example, in FIGS. 1, 2, 4, and 6. The components may be, for example, notch filters, bandpass filters, and adaptive blocks. A high-level block diagram of such a computer is illustrated in FIG. 9. Computer 902 contains a processor 904 which controls the overall operation of the computer 902 by executing computer program instructions which define such operation. The computer program instructions may be stored in a storage device 912, or other computer readable medium (e.g., magnetic disk, CD ROM, etc.), and loaded into memory 910 when execution of the computer program instructions is desired. Thus, the components and equations described herein can be defined by the computer program instructions stored in the memory 910 and/or storage 912 and controlled by the processor 904 executing the computer program instructions. For example, the computer program instructions can be implemented as computer executable code programmed by one skilled in the art to perform an algorithm defined by the components and equations described herein. Accordingly, by executing the computer program instructions, the processor 904 executes an algorithm defined by the components and equations described herein such as the components shown in FIGS. 1, 2, 4, and 6. The computer 902 also includes one or more network interfaces 906 for communicating with other devices via a network. The computer 902 also includes input/output devices 708 that enable user interaction with the computer 902 (e.g., display, keyboard, mouse, speakers, buttons, etc.) One skilled in the art will recognize that an implementation of an actual computer could contain other components as well, and that FIG. 9 is a high-level representation of some of the components of such a computer for illustrative purposes.

The foregoing Detailed Description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. An apparatus comprising:
a notch filter having a tunable zero frequency of a transfer function and configured to receive an input signal and generate an output signal;
a bandpass filter coupled to an output of the notch filter and configured to receive the output signal; and
an adaptive block coupled to the bandpass filter and configured to adjust parameters of the notch filter in order to minimize a specific cost function.

2. The apparatus of claim 1, wherein the notch filter is a digital complex filter of a 1st order, wherein an input of the digital complex filter is coupled to an input of the apparatus and the frequency of a transfer function zero of the digital complex filter is equal to an interference frequency when adaptation is complete.

3. The apparatus of claim 1, wherein the bandpass filter is a digital complex filter of a 1st order having a pole frequency that coincides with the zero frequency of the notch filter and having a transfer function of
$${H}_{bp} ( z ) = \frac{1 - {k}_{b} {z}_{0} {z}_{0}^{*}}{1 - {k}_{b} {z}_{0} {z}^{- 1}} ,$$
wherein the input of the digital complex bandpass filter is coupled to an output of the apparatus.

4. The apparatus of claim 1, wherein the adaptive block is configured to track an interference frequency and adjust the filter zero in order to achieve minimization of a cost function, the input of the adaptive block is coupled to the output of the bandpass filter.

5. The apparatus of claim 1, configured to mitigate multi-spectral interference, the notch filter having a transfer function
$${H}_{Notch} ( z ) = {H}_{1} ( z ) \cdot {H}_{2} ( z ) \cdot {H}_{3} ( z ) … {H}_{2 k} ( z ) \cdot {H}_{2 k + 1} ( z ) = \frac{1 - {z}_{0} {z}^{- 1}}{1 - {k}_{α} {z}_{0} {z}^{- 1}} \cdot \frac{1 - {z}_{0 + {Δ}_{1}} {z}^{- 1}}{1 - {k}_{α} {z}_{0 + {Δ}_{1}} {z}^{- 1}} \cdot \frac{1 - {z}_{0 - {Δ}_{1}} {z}^{- 1}}{1 - {k}_{α} {z}_{0 - {Δ}_{1}} {z}^{- 1}} … \frac{1 - {z}_{0 + {Δ}_{k}} {z}^{- 1}}{1 - {k}_{α} {z}_{0 + {Δ}_{k}} {z}^{- 1}} \cdot \frac{1 - {z}_{0 - {Δ}_{k}} {z}^{- 1}}{1 - {k}_{α} {z}_{0 - {Δ}_{k}} {z}^{- 1}} .$$

6. The apparatus of claim 1, configured to mitigate multi-spectral interference, wherein the notch filter is implemented by shifting a highpass filter after multiplying the real coefficients of its transfer function by a power function of the complex exponent.

7. A method comprising:
receiving an input signal from one or more global navigation satellite system satellites;
filtering the input signal using a first transfer function of a notch filter to generate a filtered signal;
filtering the filtered signal using a second transfer function of a bandpass filter to generate a bandpass filtered signal; and
tracking an interference frequency of the bandpass filtered signal.

8. The method of claim 7, wherein the notch filter is a digital complex filter of a 1st order, wherein the input of the digital complex filter is coupled to an input of an apparatus receiving the input signal and the frequency of a transfer function zero of the digital complex filter is equal to an interference frequency when adaptation is complete.

9. The method of claim 7, wherein the bandpass filter is a digital complex filter of a 1st order, the digital complex filter having a pole frequency that coincides with the zero frequency of the notch filter, the digital complex filter having a transfer function of
$${H}_{bp} ( z ) = \frac{1 - {k}_{b} {z}_{0} {z}_{0}^{*}}{1 - {k}_{b} {z}_{0} {z}^{- 1}} .$$

10. The method of claim 7, further comprising:
tracking an interference frequency and adjusting the filter zero in order to achieve minimization of a cost function.

11. The method of claim 7, wherein the notch filter has a transfer function
$${H}_{Notch} ( z ) = {H}_{1} ( z ) \cdot {H}_{2} ( z ) \cdot {H}_{3} ( z ) … {H}_{2 k} ( z ) \cdot {H}_{2 k + 1} ( z ) = \frac{1 - {z}_{0} {z}^{- 1}}{1 - {k}_{α} {z}_{0} {z}^{- 1}} \cdot \frac{1 - {z}_{0 + {Δ}_{1}} {z}^{- 1}}{1 - {k}_{α} {z}_{0 + {Δ}_{1}} {z}^{- 1}} \cdot \frac{1 - {z}_{0 - {Δ}_{1}} {z}^{- 1}}{1 - {k}_{α} {z}_{0 - {Δ}_{1}} {z}^{- 1}} … \frac{1 - {z}_{0 + {Δ}_{k}} {z}^{- 1}}{1 - {k}_{α} {z}_{0 + {Δ}_{k}} {z}^{- 1}} \cdot \frac{1 - {z}_{0 - {Δ}_{k}} {z}^{- 1}}{1 - {k}_{α} {z}_{0 - {Δ}_{k}} {z}^{- 1}} .$$

12. The method of claim 7, wherein the notch filter is a highpass filter that is shifted using real coefficients by multiplying the real coefficients by a power function of the complex exponent.

13. An apparatus comprising:
a processor; and
a memory coupled with the processor, the memory storing computer program instructions that when executed cause the processor to perform operations comprising:
receiving an input signal from one or more global navigation satellite system satellites;
filtering the input signal using a first transfer function of a notch filter to generate a filtered signal;
filtering the filtered signal using a second transfer function of a bandpass filter to generate a bandpass filtered signal; and
tracking an interference frequency of the bandpass filtered signal.

14. The apparatus of claim 13, wherein the notch filter is a digital complex filter of a 1st order and the zero frequency of a transfer function of the digital complex filter is equal to the interference frequency when adaptation is complete.

15. The apparatus of claim 13, wherein the bandpass filter is a digital complex filter of a 1st order, the digital complex filter having a pole frequency that coincides with the zero frequency of the notch filter, the digital complex filter having a transfer function of
$${H}_{bp} ( z ) = \frac{1 - {k}_{b} {z}_{0} {z}_{0}^{*}}{1 - {k}_{b} {z}_{0} {z}^{- 1}} .$$

16. The apparatus of claim 13, the operations further comprising:
tracking an interference frequency and adjusting the zero frequency of notch filter in order to achieve minimization of a cost function.

17. The apparatus of claim 13, wherein the notch filter has a transfer function
$${H}_{Notch} ( z ) = {H}_{1} ( z ) \cdot {H}_{2} ( z ) \cdot {H}_{3} ( z ) … {H}_{2 k} ( z ) \cdot {H}_{2 k + 1} ( z ) = \frac{1 - {z}_{0} {z}^{- 1}}{1 - {k}_{α} {z}_{0} {z}^{- 1}} \cdot \frac{1 - {z}_{0 + {Δ}_{1}} {z}^{- 1}}{1 - {k}_{α} {z}_{0 + {Δ}_{1}} {z}^{- 1}} \cdot \frac{1 - {z}_{0 - {Δ}_{1}} {z}^{- 1}}{1 - {k}_{α} {z}_{0 - {Δ}_{1}} {z}^{- 1}} … \frac{1 - {z}_{0 + {Δ}_{k}} {z}^{- 1}}{1 - {k}_{α} {z}_{0 + {Δ}_{k}} {z}^{- 1}} \cdot \frac{1 - {z}_{0 - {Δ}_{k}} {z}^{- 1}}{1 - {k}_{α} {z}_{0 - {Δ}_{k}} {z}^{- 1}} .$$

18. The apparatus of claim 13, wherein the notch filter is shifted by the interference frequency by multiplying the real coefficients of the bandpass filter transfer function by a power function of the complex exponent.
